(19) United States
(12) Patent Application Publication
(10) Pub. No.: US 2010/0104088 A1
(43) Pub. Date: Apr. 29, 2010

(54) NOISE ESTIMATION APPARATUS, CALLING APPARATUS, AND NOISE ESTIMATION METHOD

(75) Inventor: Masakazu KATO, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-shi (JP)

(21) Appl. No.: 12/605,970

(22) Filed: Oct. 26, 2009

(30) Foreign Application Priority Data
Oct. 27, 2008 (JP) 2008-275813

(51) Int. Cl. H04M 1/00; G10L 21/02

(52) U.S. Cl. 379/392.01; 704/227; 704/227; 704/E21.002

(57) ABSTRACT

In a noise estimation apparatus, a microphone converts sound into an electric signal and outputs the electric signal as a sound signal. A noise estimator performs estimation for estimating a magnitude of a noise component contained in the sound signal so as to generate an estimated noise signal. The noise estimator limits a minimum value of a noise level of the noise component contained in the sound signal during the estimation to a predetermined default value, and integrates the noise level having the limited minimum value to generate the estimated noise signal.

### BACKGROUND OF THE INVENTION

1. Technical Field

The present invention relates to a noise estimation apparatus, a calling apparatus, and a noise estimation method.

2. Background Technique

In Japanese Patent Application Publication No. Hei 7-74709 for example, a sound signal transmitting and receiving apparatus for controlling a reception volume according to the magnitude of ambient noise is disclosed. The above sound signal transmitting and receiving apparatus detects a sound level input to a transmission microphone as a noise level when no transmission sound is input, and changes the reception volume according to the detected noise level (especially, refer to claim 10 Japanese Patent Application Publication No. Hei 7-74709).

However, the sound signal input from the microphone has a signal level greatly varying at very short intervals. Accordingly, it is necessary to detect the noise level after smoothing the sound signal using an integrator or a filter. Moreover, for example, when a speaker converses with neighboring people or calls neighboring people during a telephone call, a user puts his hand over a mouthpiece so that a counterpart cannot hear sound. When covering the mouthpiece by his hand, a small amount of noise is input to the microphone. However, if the speaker removes his hand from the mouthpiece to re-start a telephone call, noise input to the microphone greatly increases. In such a manner, when an environment is abruptly changed from a low noise state for a certain time period to a high noise state, delay occurs in detecting the noise level in the above-described conventional construction of detecting the noise level from the smoothed sound signal. Therefore, the detected noise level differs from an actual noise level. Namely, the conventional construction does not follow an abrupt increase of noise and cannot accurately detect the noise level.

### SUMMARY OF THE INVENTION

The present invention is made to solve the above problem and an object thereof is to accurately estimate a magnitude of noise even when a low noise state continuing for a certain time period is abruptly changed to a high noise state.

To solve the above problem, a noise estimation apparatus according to the present invention comprises: a microphone that converts sound into an electric signal and outputs the electric signal as a sound signal; and a noise estimator that performs estimation for estimating a magnitude of a noise component contained in the sound signal so as to generate an estimated noise signal, wherein the noise estimator limits a minimum value of a noise level of the noise component contained in the sound signal during the estimation to a predetermined default value, and integrates the noise level having the limited minimum value to generate the estimated noise signal.

According to the above construction, the noise estimator limits a minimum value of a noise level generated during the estimation to a predetermined default value, and integrates the limited noise level to generate the estimated noise signal. Therefore, even if noise input to the microphone maintains a low state for a certain time period, the estimated noise signal generated by integrating the noise level is not decreased to a default value or less. Accordingly, a magnitude of noise can be accurately estimated even when a low noise state continuing for a certain time period is abruptly changed to a high noise state.

Further, the “noise level generated during estimation” corresponds to, for example, an output from a noise detector 20A illustrated in FIG. 1, an output from an adder 26 illustrated in FIG. 2, or an output from a noise detector 20A′ shown in FIG. 6.

In the noise estimation apparatus, the noise estimator may include an amplitude detection circuit that detects an amplitude of the sound signal to generate an amplitude signal representing the noise level of the noise component contained in the sound signal, and an integral circuit that integrates the amplitude signal. The integral circuit includes a minimum value limiting circuit that limits the minimum value of the noise level represented by the amplitude signal generated during the estimation to the predetermined default value. For example, a circuit construction illustrated in FIG. 2 corresponds to the noise estimator.

In the noise estimation apparatus, the integral circuit may include: a delay circuit that delays an output of the minimum value limiting circuit; and a mixing circuit that mixes the amplitude signal and an output of the delay circuit at a prescribed ratio, wherein the output of the minimum value limiting circuit is obtained as the estimated noise signal by supplying an output of the mixing circuit to an input of the minimum value limiting circuit. For example, the integral circuit corresponds to the circuit construction illustrated in FIG. 2.

In the noise estimation apparatus, the noise estimator may include a noise detection circuit that detects the noise level of the noise component contained in the sound signal; a minimum value limiting circuit that limits the minimum value of the noise level detected during the estimation to the predetermined default value; and a smoothing circuit that smoothes an output of the minimum value limiting circuit. For example, a construction circuit illustrated in FIG. 6 corresponds to the noise estimator.

A calling apparatus according to the present invention comprises: a microphone that converts sound into an electric signal and outputs the electric signal as a sound signal; a noise estimator that performs estimation for estimating a magnitude of a noise component contained in the sound signal so as to generate an estimated noise signal, wherein the noise estimator limits a minimum value of a noise level of the noise component contained in the sound signal during the estimation to a predetermined default value, and integrates the noise level having the limited minimum value to generate the estimated noise signal; and a sound emphasis processor that applies emphasis processing to a transmission voice to be transmitted from the calling apparatus or a reception voice to be received by the calling apparatus by an emphasis amount corresponding to the magnitude of the estimated noise signal.

In accordance with this construction, the sound emphasis processing can be accurately applied to the transmission voice or reception voice even when a low noise state continuing for a certain time period is abruptly changed to a high noise state.

The sound emphasis processing includes changing frequency characteristics of the transmission voice or reception voice, or compressing a dynamic range thereof to improve S/N in listening, in addition to adjusting the volume of the transmission voice or reception voice.

In the calling apparatus, the transmission voice is contained in the sound signal outputted from the microphone or contained in a transmission sound signal generated from a transmission microphone which is separately provided from the microphone. The calling apparatus may include: a receiver that receives a reception sound signal; and a codec that decodes or expands the reception sound signal received by the receiver, wherein the reception voice is contained in the reception sound signal outputted from the codec.

A noise estimation method according to the present invention comprising: a first step of generating a sound signal by converting sound into an electric signal and outputting the electric signal as the sound signal; and a second step of generating an estimated noise signal by performing estimation for estimating a magnitude of a noise component contained in the sound signal, wherein the second step limits a minimum value of a noise level of the noise component contained in the sound signal during the estimation to a predetermined default value, and generates the estimated noise signal by integrating the noise level having the limited minimum value.

The present invention may include a talking voice control method comprising: a first step of generating a sound signal by converting sound into an electric signal and outputting the electric signal as the sound signal; a second step of generating an estimated noise signal by performing estimation for estimating a magnitude of a noise component contained in the sound signal, and a third step of performing sound emphasis processing by an emphasis amount according to the magnitude of the estimated noise signal, wherein the second step limits a minimum value of a noise level of the noise component contained in the sound signal during the estimation to a predetermined default value, and generates the estimated noise signal by integrating the noise level having the limited minimum value.

### BRIEF DESCRIPTION OF THE DRAWINGS

FIG. 1 is a block diagram illustrating the construction of main parts of a telephone 1 according to a first embodiment of the invention.

FIG. 2 is a block diagram illustrating a detailed circuit construction of a noise estimator.

FIG. 3 is a waveform chart illustrating an example of a sound signal input from a microphone.

FIG. 4 is a waveform chart illustrating an estimated noise signal.

FIG. 5 is a graph illustrating-a transmission volume and a reception volume.

FIG. 6 is a block diagram illustrating the construction of main parts of a telephone 1 according to a second embodiment of the invention.

FIG. 7 is a block diagram illustrating the construction of main parts of a telephone according to a modified example of the invention.

### DETAILED DESCRIPTION OF THE INVENTION

Hereinafter, embodiments of the present invention will be described with reference to the accompanying drawings.

In the fowling embodiments, a description will be given of the case where the present invention is applied to a telephone.

### First Embodiment

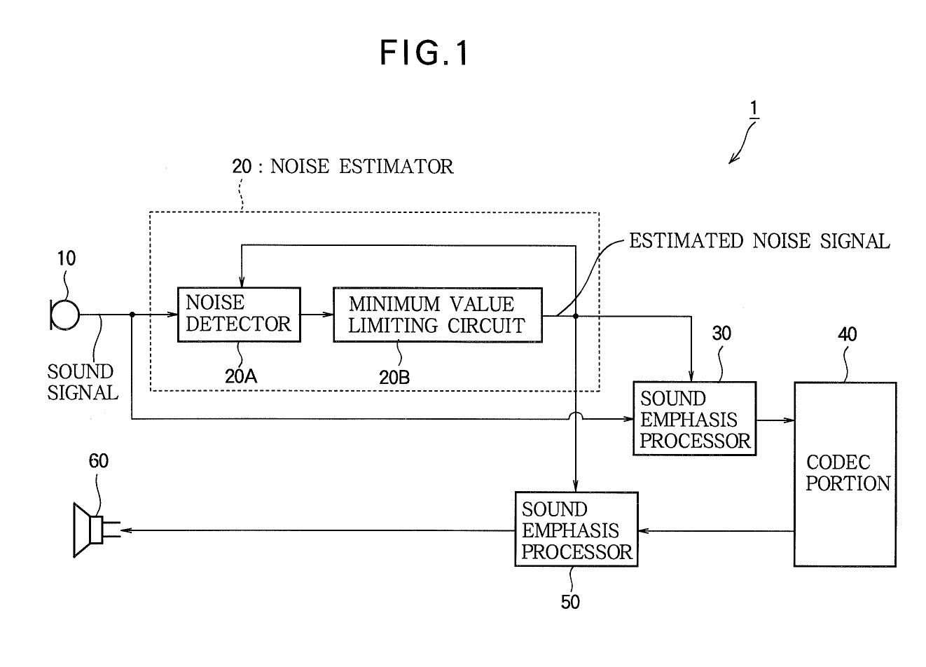

FIG. 1 is a block diagram illustrating the construction of main parts of a telephone 1 according to a first embodiment.

A microphone 1 picks up a transmission sound and ambient noise and converts the transmission sound and noise into an electric signal, thereby generating the converted electric signal as a sound signal. A noise estimator 20 estimates the magnitude of a noise component included in the sound signal and generates an estimated noise signal indicating the magnitude of the noise component. The noise estimator 20 includes a noise detector 20A and a minimum value limiting circuit 20B. The estimated noise signal, together with the sound signal from the microphone, is fed back to the noise detector 20A.

The minimum value limiting circuit 20B limits a minimum value of a noise level (a noise level generated during estimation) generated from the noise detector 20A to a predetermined default value. In more detail, the minimum value limiting circuit 20B compares a noise level generated from the noise detector 20A with the predetermined default value. If the noise level is less than the default value, the minimum value limiting circuit 20B changes the noise level to the default value. Meanwhile, if the noise level is above the default value, the minimum value limiting circuit 20B generates the noise level supplied from the noise detector 20A without any change. Namely, the minimum value limiting circuit 20B compares the varying noise level with the default value, and operates when the varying noise level lowers below the default value for truncating the varying noise level by the default value to thereby limit the minimum value of the noise level to the default value. An output of the minimum value limiting circuit 20B is a final noise level (the estimated noise signal) estimated by the noise estimator 20 and the final noise level is fed back to the noise detector 20A and simultaneously is supplied to sound emphasis processors 30 and 50.

The sound emphasis processor 30 performs sound emphasis processing by an emphasis amount according to a value of the estimated noise signal, with respect to the sound signal (transmission sound signal) supplied from the microphone 10 when the value of the estimated noise signal is above a predetermined reference value. For example, the sound emphasis processor 30 adjusts, as sound emphasis processing, a signal level of the transmission sound signal so that the signal level can be a transmission volume proportional to a value of the estimated noise signal. Further, the sound emphasis processing is not limited to adjusting the transmission volume and may include changing frequency characteristics of the transmission sound signal, or compressing a dynamic range of the transmission sound signal to improve S/N in listening, thereby easily listening to transmission sound. Moreover, if the value of the estimated noise signal is less than the reference value, the sound emphasis processor 30 does not perform the sound emphasis processing. In this case, the transmission sound signal supplied from the microphone 10 is input to a codec portion 40 through the sound emphasis processor 30.

The codec portion 40 performs coding or compression processing with respect to the transmission sound signal supplied from the sound emphasis processor 30. The transmission sound signal upon which coding or compression processing is performed is transmitted to a telephone of a counterpart through a communication portion (transmitter) which is not shown. Moreover, the codec portion 40 performs decoding or expansion processing with respect to a reception sound signal received from the telephone of the counterpart by a communication portion (receiver) which is not shown.

The sound emphasis processor 50 performs sound emphasis processing by an emphasis amount according to a value of the estimated noise signal, with respect to the reception sound signal supplied from the codec portion 40 when the value of the estimated noise signal is above a predetermined reference value. For example, the sound emphasis processor 50 adjusts, as sound emphasis processing, a sound volume of the reception signal so that the sound volume can be a reception volume proportional to a value of the estimated noise signal. Further, the sound emphasis processing performed in the sound emphasis processor 50 is not limited to adjusting the reception volume and may include changing frequency characteristics of the reception sound signal, or compressing a dynamic range of the reception signal to improve S/N in listening, thereby easily listening to reception sound. Moreover, if the value of the estimated noise signal is less than the reference value, the sound emphasis processor 50 does not perform the sound emphasis processing. In this case, the reception sound signal supplied from the codec 40 is input to a speaker 60 through the sound emphasis processor 50. The speaker 60 outputs the reception sound based on the reception sound signal supplied from the sound emphasis processor 50.

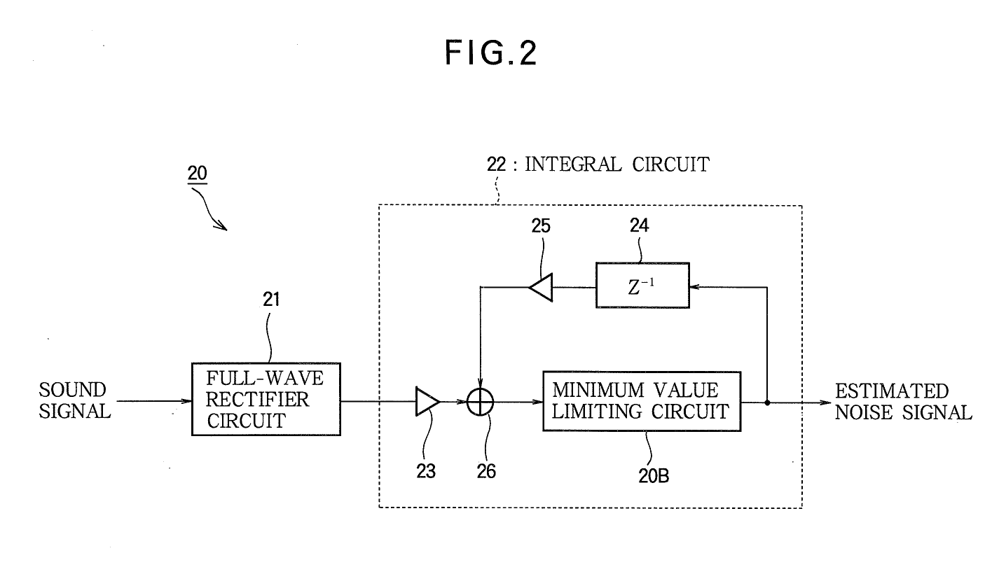

FIG. 2 is a block diagram illustrating a detailed circuit construction of the noise estimator 20. The noise estimator 20 includes a full-wave rectifier circuit 21 for full-wave rectifying the sound signal generated from the microphone 10, and an integral circuit 22 for integrating an output of the full-wave rectifier circuit 21. The integral circuit 22 includes multipliers 23 and 25, a delay circuit (Z⁻¹) 24, an adder 26, and a minimum value limiting circuit 20B. The noise estimator 20 serves as an IIR low-pass filter. The frequency characteristics of the noise estimator 20 are determined by coefficients of the multipliers 23 and 25 and a delay time of the delay circuit 24. Namely, the noise estimator 20 may function as a low-pass filter which passes only components of a frequency band lower than, for example, transmission sound (voice emitted by humans), by appropriately determining the coefficients or delay time.

The full-wave rectifier circuit 21 detects an amplitude of the sound signal by performing full-wave rectification and generates the amplitude of the sound signal as an amplitude signal. A prescribed coefficient from provided from the multiplier 23 is multiplied to the amplitude signal. A half-wave rectifier circuit 21 may be used instead of the full-wave rectifier circuit 21. The delay circuit 24 delays output timing of the fed back estimated noise signal by a prescribed time. A prescribed coefficient provided from the multiplier 25 is multiplied to an output of the delay circuit 24.

The adder 26 is a mixing circuit that adds a signal input through the full-wave rectifier circuit 21 and the multiplier 23 to a signal fed back through the delay circuit 24 and the multiplier 25 from the minimum value limiting circuit 20B. Accordingly, an average or mixture of a current noise level and past noise level which was estimated in the past is calculated. The minimum value limiting circuit 20B compares a noise level (a noise level generated during estimation) output from the adder 26 with a default value, and changes the noise level when the noise level is less than the default value. An output from the minimum value limiting circuit 20B, which is an estimated noise signal, is fed back to the adder 26 through the delay circuit 24 and the multiplier 25 and simultaneously is supplied to the sound emphasis processors 30 and 50.

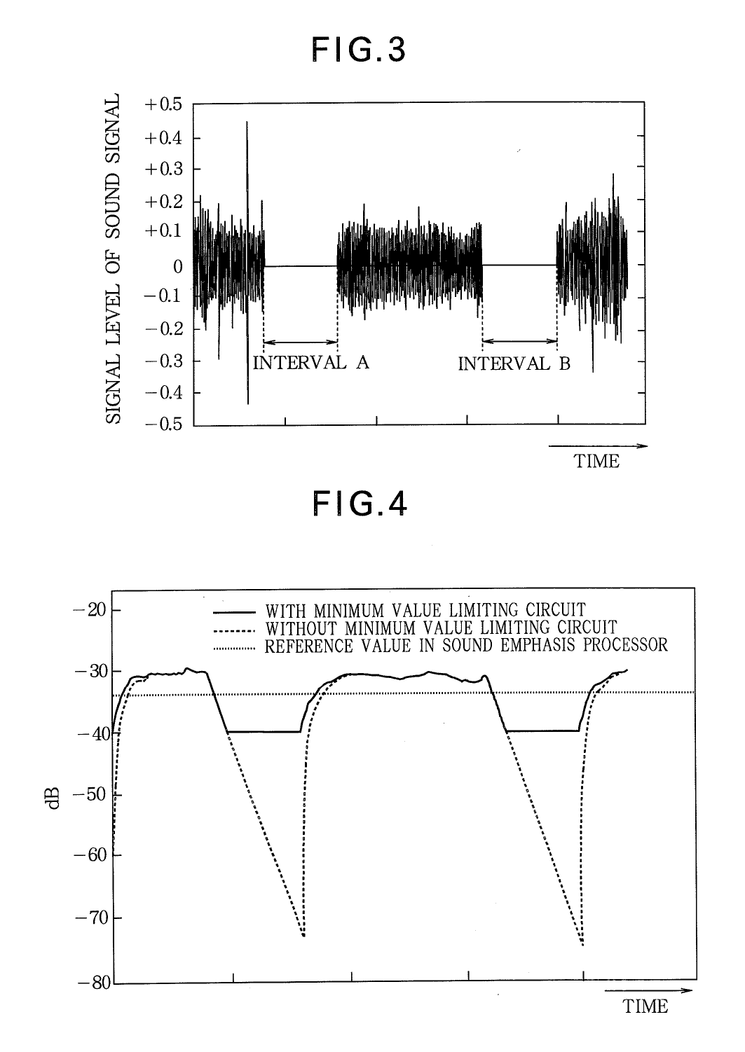

FIG. 3 is a waveform chart illustrating an example of a sound signal input from the microphone 10.

An interval A or B shown in FIG. 3 denotes an interval during which a user places his hand over a mouthpiece in order to converse with other people during a telephone call or to call other people. If the user removes his hand from the mouthpiece, a low noise state during the interval A or B is changed to a high noise state. In this embodiment, the case where a user removes his hand from the mouthpiece is exemplarily described, as the case where the low noise state continues for a certain time period and thereafter the low noise state is abruptly changed to the high noise state. Moreover, the case where noise is abruptly increased further includes, for example, the case where an ambient noise level is changed from a low state to a high state by opening a window or door when a telephone 1 is a fixed phone installed in an indoor space, or the case where an ambient noise level is changed from a low environment to a high environment when the telephone 1 is a cellular phone.

FIG. 4 is a waveform chart illustrating an estimated noise signal.

FIG. 4 shows, for comparison, a waveform of an estimated noise signal generated when the sound signal illustrated in FIG. 3 is input in the noise estimator 20 illustrated in FIG. 2, and another waveform of an estimated noise signal in case that the minimum value limiting circuit 20B is not included in the noise estimator 20 illustrated in FIG. 2. If the minimum value limiting circuit 20B is not included, the noise estimator 20 does not limit a minimum value of a noise level output from the adder 26. Therefore, if a state wherein a user puts his hand over a mouthpiece, that is, a state wherein less noise is input to the microphone 10 continues, a signal level of the estimated noise signal which is an output from the integral circuit 22 is continuously decreased up to −75 dB as illustrated in FIG. 4. If the user removes his hand from the mouthpiece and thus noise input to the microphone 10 is increased, since the signal level decreased up to −75 dB cannot respond quickly, delay occurs in estimating the noise level. Accordingly, the noise estimator 20 does not follow an abrupt increase in noise and cannot accurately estimate the noise level.

Meanwhile, the telephone 1 (noise estimator 20) according to this embodiment limits a minimum value of a noise level output from the adder 26 to −40 dB by the minimum value limiting circuit 20B. Therefore, as illustrated in FIG. 4, even though the state wherein a user puts his hand over a mouthpiece continues, a signal level of an estimated noise signal is not decreased to −40 dB or less. Further, as illustrated in FIG. 4, if the user removes his hand from the mouthpiece, the signal level can be more rapidly increased as compared with the case where the minimum value limiting circuit 20B is not included. Hence, delay of estimation of the noise level is suppressed, thereby improving subsequent operation.

In an example illustrated in FIG. 4, a reference value used to judge whether sound emphasis processing is performed in the sound emphasis processors 30 and 50 is set to −34 dB. In addition, a default value in the minimum value limiting circuit 20B used for comparison with an output from the noise detector 20A is set to −40 dB. That is, the default value in the minimum value limiting circuit 20B is set to be less than the reference value in the sound emphasis processors 30 and 50 by 6 dB. Thus the default value in the minimum value limiting circuit 20B needs to have a value smaller than the reference value in the sound emphasis processors 30 and 50. However, since it is meaningless for the default value in the minimum value limiting circuit 20B to be much less than the reference value in the sound emphasis processors 30 and 50, the default value in the minimum value limiting circuit 20B needs to be set such that the default value has a value (e.g., a few dB or so) appropriately smaller than the reference value in the sound emphasis processors 30 and 50.

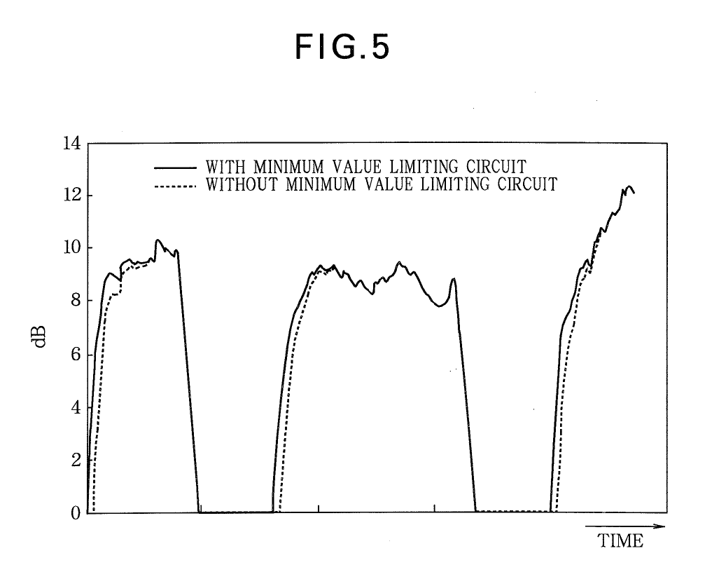

FIG. 5 is a graph illustrating a transmission volume and a reception volume.

The graph illustrated in FIG. 5 shows an example for adjusting a transmission volume or a reception volume as sound emphasis processing. As described above, if the minimum value limiting circuit 20B is not included and if a user removes his hand from a mouthpiece, delay occurs in estimating a noise level. Therefore, timing for emphasizing sound is retarded and it is difficult to listen to transmission sound or reception sound. However, the telephone 1 (noise estimator 20) according to the embodiment suppresses delay of the estimation of the noise level. Therefore, as illustrated in FIG. 5, a gain of a transmission volume or reception volume when a user removes his hand from a mouthpiece can be rapidly increased as compared with the case where the minimum value limiting circuit 20B is not included. Namely, since timing for emphasizing sound can be shortened as compared with the case where the minimum value limiting circuit 20B is not included, ease of listening to the transmission sound or reception sound can be improved.

As described above, the telephone 1 (noise estimator 20) of the embodiment provides the minimum value limiting circuit 20B, limits a minimum value of a noise level generated during estimation to a predetermined default value, and integrating the noise level where very low levels are replaced by default value, thereby generating an estimated noise signal. Accordingly, even if a user puts his hand over a mouthpiece and thus a low state of noise input to the microphone 1 continues, the estimated noise signal is not decreased to a value less than the default value. As a result, even if there is an abrupt change in noise to a high noise state after a low noise state continues for a certain time period, the magnitude of noise can be accurately estimated. Further, ease of listening to transmission voice or reception voice can be improved. Furthermore, the minimum value limiting circuit 20B can be mounted by a simple construction of insertion.

### Second Embodiment

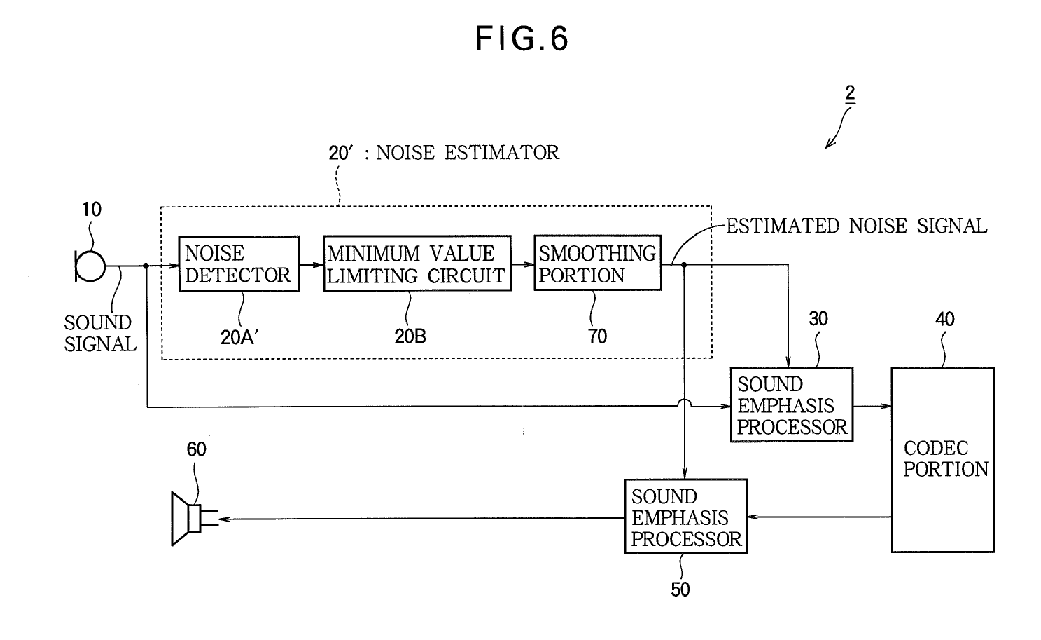

FIG. 6 is a block diagram illustrating the construction of main parts of a telephone 1 according to a second embodiment.

As illustrated in FIG. 6, a telephone 2 according to a second embodiment has the same construction as the telephone 1 of the first embodiment, except for the construction of a noise estimator 20′. The noise estimator 20′ includes a noise detector 20A′, a minimum value limiting circuit 20B, and a smoothing portion 70. The noise detector 20A′ detects the magnitude of a noise component included in a sound signal and generates a noise level indicating the magnitude of the detected noise component.

The minimum value limiting circuit 20B limits a minimum value of a noise level (a noise level generated during estimation) generated from the noise detector 20A′ to a predetermined default value. In more detail, the minimum value limiting circuit 20B compares a noise level generated from the noise detector 20A′ with the predetermined default value. If the noise level is less than the default value, the minimum value limiting circuit 20B changes the noise level to the default value. Meanwhile, if the noise level is above the default value, the minimum value limiting circuit 20B generates the noise level supplied from the noise detector 20A′ without any change. As in the first embodiment, the default value in the minimum value limiting circuit 20B is set to have a smaller value than a reference value in sound emphasis processors 30 and 50 used by about a few dB.

The smoothing portion 70 is comprised of an integral circuit or a filter to smooth an output of the minimum value limiting circuit 20B. An output from the smoothing portion 70 is a final noise level (estimated noise signal) estimated by the noise estimator 20′ and is supplied to the sound emphasis processors 30 and 50.

Thus, even though the smoothing portion 70 is provided at a rear part of the minimum value limiting circuit 20B without feeding back the estimated noise signal, the noise estimator 20′ limits the minimum value of the noise level output from the noise detector 20A′ by the limiting circuit 20B and then smoothes (integrates) the limited minimum value, thereby generating the estimated noise signal. Therefore, the same effect as in the first embodiment can be obtained.

### Modified Example

The present invention is not limited to the above-described embodiments and may be modified, for example, as described hereinbelow. In addition, two or more modified examples described below properly combined.

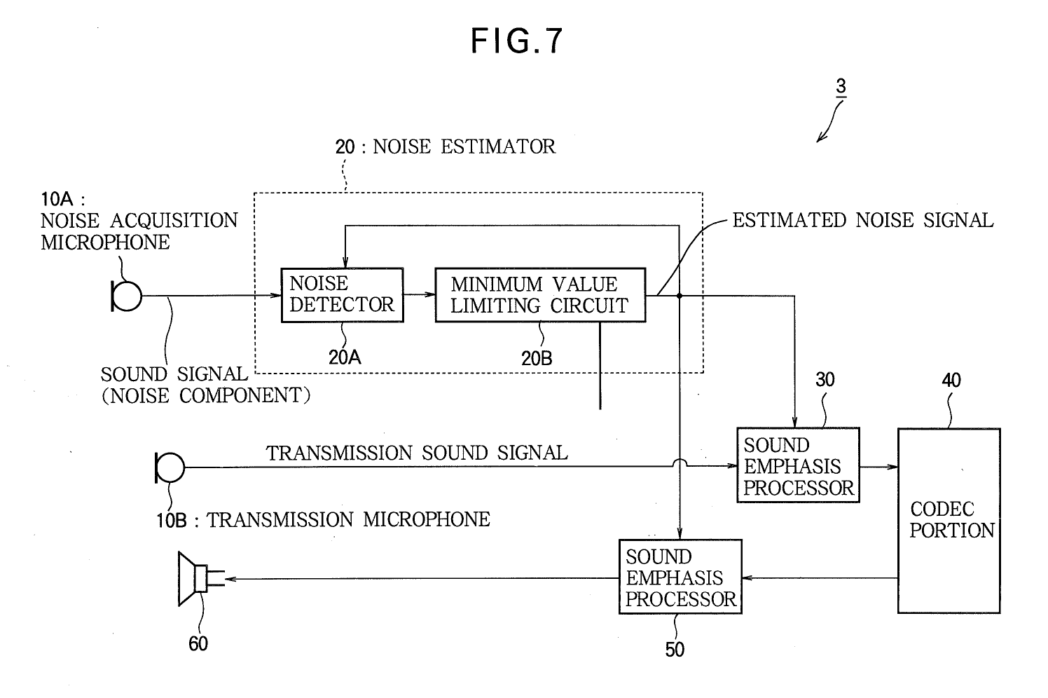

(1) As illustrated in FIG. 7, a noise acquisition microphone 10A may be provided in addition to a transmission microphone 10B for input transmission sound. In this case, the noise acquisition microphone 10A is provided at a place different from a position of a mouthpiece where the transmission microphone 10B is provided. That is, the noise acquisition microphone 10A is arranged at a place away from a mouthpiece of the telephone 1 such as a rear side of a housing etc. so that sound (transmission sound) of a caller may not be input to the microphone 10A. Therefore, a noise level can be estimated with higher accuracy from a sound signal input from the noise acquisition microphone 10A. In the construction shown in FIG. 7, a sound signal output from the noise acquisition microphone 10A is supplied only to the noise estimator 20. The sound emphasis processor 30 performs sound emphasis process by an emphasis amount according to a value of an estimated noise signal.

(2) Although in the above-described embodiments the sound emphasis processing is performed with respect to both transmission sound and reception sound, the sound emphasis processing may be performed with respect to either transmission sound or reception sound. If the sound emphasis processing is performed with respect only to transmission sound, the sound emphasis processor 50 for reception sound is not necessary. Moreover, if the sound emphasis processing is performed with respect only to reception sound, the sound emphasis processor 30 for transmission sound is not necessary.

(3) Between a sound interval during which transmission sound is input and a noise interval during which only noise is input, a noise level can be accurately estimated preferably in the noise interval. Accordingly, it may be determined whether there is transmission sound by analyzing a signal level, a frequency spectrum, autocorrelation, etc. with respect to a sound signal input from the microphone 10 and a noise level may be estimated from a sound signal in the noise interval after detecting the noise interval from the determination result. Moreover, the noise level of the sound interval can be more accurately estimated by obtaining the noise level of the sound interval in consideration of the noise level estimated in the noise interval.

(4) The present invention may be used as a noise estimation apparatus for estimating the magnitude of ambient noise using a microphone. For example, the present invention may be applied to a noise measurement apparatus for measuring the magnitude of noise in acoustic spaces such as a studio, a concert hall, or a Karaoke room. Although in the above-described embodiments the calling apparatus according to the present invention is applied to a telephone, the calling apparatus is applicable to a wireless apparatus or an interphone. The telephone includes a fixed telephone, a cellular phone, an IP telephone, a television telephone, and the like.

1. A noise estimation apparatus comprising:
a microphone that converts sound into an electric signal and outputs the electric signal as a sound signal; and
a noise estimator that performs estimation for estimating a magnitude of a noise component contained in the sound signal so as to generate an estimated noise signal,
wherein the noise estimator limits a minimum value of a noise level of the noise component contained in the sound signal during the estimation to a predetermined default value, and integrates the noise level having the limited minimum value to generate the estimated noise signal.

2. The noise estimation apparatus according to claim 1,
wherein the noise estimator includes an amplitude detection circuit that detects an amplitude of the sound signal to generate an amplitude signal representing the noise level of the noise component contained in the sound signal, and an integral circuit that integrates the amplitude signal, and
wherein the integral circuit includes a minimum value limiting circuit that limits the minimum value of the noise level represented by the amplitude signal generated during the estimation to the predetermined default value.

3. The noise estimation apparatus according to claim 2,
wherein the integral circuit includes: a delay circuit that delays an output of the minimum value limiting circuit; and a mixing circuit that mixes the amplitude signal and an output of the delay circuit at a prescribed ratio, and
wherein the output of the minimum value limiting circuit is obtained as the estimated noise signal by supplying an output of the mixing circuit to an input of the minimum value limiting circuit.

4. The noise estimation apparatus according to claim 1, wherein the noise estimator comprises:
a noise detection circuit that detects the noise level of the noise component contained in the sound signal;
a minimum value limiting circuit that limits the minimum value of the noise level detected during the estimation to the predetermined default value; and
a smoothing circuit that smoothes an output of the minimum value limiting circuit.

5. The noise estimation apparatus according to claim 1, wherein the noise estimator comprises: a noise detection circuit that detects the noise level of the noise component contained in the sound signal, the noise level varying dependently on an amount of the sound around the microphone; and a minimum value limiting circuit that compares the varying noise level with the default value, and operates when the varying noise level lowers below the default value for truncating the varying noise level by the default value to thereby limit the minimum value of the noise level to the default value.

6. A calling apparatus comprising:
a microphone that converts sound into an electric signal and outputs the electric signal as a sound signal;
a noise estimator that performs estimation for estimating a magnitude of a noise component contained in the sound signal so as to generate an estimated noise signal, wherein the noise estimator limits a minimum value of a noise level of the noise component contained in the sound signal during the estimation to a predetermined default value, and integrates the noise level having the limited minimum value to generate the estimated noise signal; and
a sound emphasis processor that applies emphasis processing to a transmission voice to be transmitted from the calling apparatus or a reception voice to be received by the calling apparatus by an emphasis amount corresponding to the magnitude of the estimated noise signal.

7. The calling apparatus according to claim 6, wherein the transmission voice is contained in the sound signal outputted from the microphone or contained in a transmission sound signal generated from a transmission microphone which is separately provided from the microphone.

8. The calling apparatus according to claim 6, wherein the calling apparatus includes: a receiver that receives a reception sound signal; and a codec that decodes or expands the reception sound signal received by the receiver, wherein the reception voice is contained in the reception sound signal outputted from the codec.

9. A noise estimation method, comprising:
a first step of generating a sound signal by converting sound into an electric signal and outputting the electric signal as the sound signal; and
a second step of generating an estimated noise signal by performing estimation for estimating a magnitude of a noise component contained in the sound signal,
wherein the second step limits a minimum value of a noise level of the noise component contained in the sound signal during the estimation to a predetermined default value, and generates the estimated noise signal by integrating the noise level having the limited minimum value.
